(19) United States
(12) Patent Application Publication
(10) Pub. No.: US 2005/0153211 A1
(43) Pub. Date: Jul. 14, 2005

(54) Hologram device, its production method, and electronic optical part

(75) Inventors: Hirotoshi Takemori, Onomichi-shi (JP); Masahiro Tsujimura, Higashihiroshima-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/025,911

(22) Filed: Jan. 3, 2005

(30) Foreign Application Priority Data
Jan. 8, 2004 (JP) 2004-003164

(51) Int. Cl. G03H 1/04

(52) U.S. Cl. 430/1; 430/2; 359/27; 385/37

(57) ABSTRACT

A hologram device of the invention comprises a substrate having a hologram diffraction lattice thereon and a low moisture-permeable film formed on the substrate and covering the hologram diffraction lattice, wherein the substrate has an exposed region not covered with the low moisture-permeable film.

### CROSS-REFERENCE TO RELATED APPLICATION

This application is related to Japanese application No.2004-003164 filed on Jan. 8, 2004 whose priority is claimed under 35 USC §119, the disclosure of which is incorporated by reference in its entirety.

### BACKGROUND OF THE INVENTION

1. Field of the invention

The invention relates to a hologram device, its production method, and an electronic optical part provided with the hologram device. The hologram device of the invention is preferably used for a pick-up part for an optical disk such as CD, CD-ROM, MD, and LD.

2. Description of Related Art

FIG. 4 is a side view showing the structure of a conventional hologram device 51. The conventional hologram device 51 comprises ultraviolet-curable resin layers 55a, 55b on both faces of a transparent substrate 52 made of an acrylic resin through primer layers 53a and 53b. Hologram diffraction lattices are formed on the ultraviolet-curable resin layers 55a, 55b by a photo polymer method or the like. Dielectric films 57a, 57b as antireflection films are formed on substantially entire faces of the ultraviolet-curable resin layers 55a, 55b in both faces (e.g. reference to Japanese Unexamined Patent Publication No. Hei11-311711(1999)) The transparent substrate 52 made of an acrylic resin has a high moisture absorption property and is swollen by moisture absorption. In the case dielectric layers with low moisture-permeability are formed entirely on both faces of the transparent substrate 52, the acrylic resin substrate absorbs moisture only from the sides and is swollen by the absorption and thereby swelling strain is generated.

In the case the hologram device 51 is to be fixed in a laser unit comprising a laser chip and a beam detection member by a firmly fixing method such as 4-point fixation or 4-edge fixation, cracks are possibly formed in the resin substrate because of the swelling stress under the conditions of 60° C. and 90% RH.

### SUMMARY OF THE INVENTION

In view of the above-mentioned state of the art, the invention aims to lessen the swelling strain of the substrate and to prevent crack formation in the hologram device.

A hologram device of the invention comprises a substrate having a hologram diffraction lattice thereon and a low moisture-permeable film formed on the substrate and covering the hologram diffraction lattice, wherein the substrate has an exposed region not covered with the low moisture-permeable film.

In general, a crack formation ratio is affected by swelling strain caused by moisture absorption property of a substrate. The hologram device of the invention comprises a substrate having an exposed region not covered with a low moisture-permeable film, so that moisture is absorbed also from the face wherein the low moisture-permeable film is formed. Therefore, the swelling strain is moderated to prevent crack formation.

### BRIEF DESCRIPTION OF THE DRAWINGS

FIG. 1 is a side view showing the structure of a hologram device according to Example 1 of the invention.

FIG. 2 is a side view showing the structure of a hologram device according to Example 2 of the invention.

FIG. 3 is a sectional side view showing the structure of a hologram laser unit according to Example 3 of the invention.

FIG. 4 is a side view showing the structure of a conventional hologram device.

### DESCRIPTION OF THE PREFERRED EMBODIMENTS

The hologram device of the invention comprises a substrate having a hologram diffraction lattice thereon and a low moisture-permeable film formed on the substrate and covering the hologram diffraction lattice, wherein the substrate has an exposed region not covered with the low moisture-permeable film.

In this specification, “exposed region” means an exposed region with a proper size to yield the effect of the invention by the principle or the function of the invention. A defect of a coating of a low moisture-permeable film and an exposed region formed by a scratch of a coating are not included in the “exposed region” of the invention.

Such a hologram device can be formed, for example, by the following two methods.

(First Method)

A production method of a hologram device according to the first method comprises (1) forming a plurality of hologram diffraction lattices on a substrate; (2) forming a low moisture-permeable film on the substrate so as to cover the hologram diffraction lattices; (3) forming grooves with a prescribed depth so as to define the hologram diffraction lattices; and (4) dicing the substrate in such a manner that bottom parts of the grooves remain.

The above-mentioned step (1), that is, a step of forming a plurality of hologram diffraction lattices on a substrate will be described.

As the substrate, for example, materials having transparency to visible laser beam such as acrylic resin, polyolefin resin, PET resin, PP resin, or glass can be used. In the case of forming the diffraction lattices by a photo polymer method, which will be described later, the substrate is preferable to have high transmissivity to ultraviolet rays. In the case of using acrylic resin for the substrate, since acrylic resin has high moisture absorption property, the invention is particularly effective.

The hologram diffraction lattices may be formed on either a part of the substrate or entire face of the substrate. Each hologram diffraction lattice may be divided into a plurality of sections with different lattice intervals, duty ratio, and groove shapes.

The hologram diffraction lattices can be formed, for example, by the following two methods.

The first formation method of the hologram diffraction lattices comprises (a) forming a mask corresponding to the patterns of the diffraction lattices on the substrate by photolithography and etching technique and (b) carrying out anisotropic etching to a prescribed depth by using the mask.

The anisotropic etching can be carried out by a reactive ion etching method in gas atmosphere of CF₄ and CHF₃.

The second formation method of the hologram diffraction lattices is a method so-called photo polymer method and comprises (a) pressurizing a master plate having a form corresponding to the patterns of the hologram diffraction lattices and the substrate so that they closely unite through an ultraviolet-curable or thermosetting resin and (b) radiating light or applying heat to them in such a state.

As a material, acrylic type ultraviolet-curable resin is preferably used. Also, a step of forming a primer layer to increase the adhesion strength between the substrate and the light or thermosetting resin may be added before the step (a).

Next, the above-mentioned step (2), that is, a step of forming a low moisture-permeable film on the substrate so as to cover the hologram diffraction lattices, will be described.

“so as to cover the hologram diffraction lattices” includes the case a plurality of hologram diffraction lattices are covered entirely or partially. Also, it includes the case each hologram diffraction lattice is covered entirely or partially.

The low moisture-permeable film is a film having a function of lowering the moisture absorption property of the substrate through the film by being formed on the substrate. The low moisture-permeable film also includes a film having moisture permeability to a certain extent to that the aim of the invention can be achieved.

The low moisture-permeable film may be, for example, an inorganic dielectric film. Specifically, the inorganic dielectric film can be composed by forming the first layer on the substrate and the second layer thereon. The first layer may be a layer of a mixture of titanium oxide and zirconium oxide, and the second layer may be a silicon oxide layer. Such a film may be formed, for example, with RF ion plating methods. The film with such a structure is stuck firmly to a plastic substrate such as an acrylic substrate, causes no film separation in a high temperature test at 85° C. for 500 H, a low temperature test at −40° C. for 500 H, a cycle test of 500 cycles of −40° C. [symbol] 85° C., and a high temperature and high humidity test at 60° C. and 90% RH for 500 H, scarcely shows a variation of optical properties and thus becomes an antireflection film with high reliability.

The low moisture-permeable film works, for example, as an antireflection film and/or protection film for protecting the diffraction lattices.

Next, the step (3), that is, a step of forming grooves with a prescribed depth so as to define the hologram diffraction lattices, will be described.

The grooves are formed, for example, by using a 0.3 mm-thick dicing blade. Formation of the grooves removes the low moisture-permeable film and forms exposed regions. As the exposed regions are wider, the swelling strain of the substrate can be decreased more. Therefore, the shape of the grooves is more preferable if their width is wider and their depth is deeper. If the depth of the grooves is ¾ or more of the thickness of the substrate, the substrate is easily broken and therefore, the depth of the grooves is preferably in a range of ⅓ to ¾ of the thickness of the substrate.

Next, the step (4), that is, a dicing the substrate in such a manner that bottom parts of the grooves remain, will be described.

Dicing can be carried out using, for example, a 0.3 mm-thick dicing blade. In this step, the substrate is diced to obtain respective hologram devices. Since the substrate is diced in such a manner that bottom parts of the grooves remain, the respective hologram devices have grooves, and exposed regions are formed in the grooves. According to this method, the exposed regions are easily formed.

Further, the substrate can be diced in such a manner that one side of side walls of each groove is removed and bottom parts of the grooves are left to remain. In such a case, each hologram device has a step at an end of the surface and a lower part of the step is not covered with the low moisture-permeable film. Therefore, an exposed region is formed in the lower part of the step. The outer shape of the hologram device can be made smaller by forming the step at the end of the surface. Therefore, if the hologram device is assembled in an optical pick-up, it could more easily avoid interference with other members and enable the optical pick-up to be smaller. (Second method) The production method of the hologram device according to the second method comprises (1) forming a plurality of hologram diffraction lattices on a substrate; (2) forming a low moisture-permeable film on the substrate by using a mask having openings in regions corresponding to the hologram diffraction lattices so as to form exposed regions not covered with the low moisture-permeable films on the substrate; and (3) dicing the substrate so as to define the hologram diffraction lattices.

The above-mentioned step (1) is the same as that in the first method.

Accordingly, the above-mentioned step (2), that is, a step of forming a low moisture-permeable film on the substrate by using a mask having openings in regions corresponding to the hologram diffraction lattices so as to form exposed regions not covered with the low moisture-permeable film on the substrate, will be described at first.

The above-mentioned “a mask having openings in regions corresponding to the hologram diffraction lattices” includes a mask having openings corresponding to all or some of a plurality of hologram diffraction lattices. Also, it includes a mask having openings corresponding to a part of each hologram diffraction lattice. Further, it includes a mask having openings in regions other than the hologram diffraction lattices. If the low moisture-permeable film is formed using such a mask, the low moisture-permeable film is formed in the openings and the exposed regions are formed in the regions covered with the mask. Owing to the exposed regions, the swelling strain of the substrate is lessened and the aim of the invention can be achieved. In order to widen the exposed regions as much as possible, the low moisture-permeable film is preferably formed so as to cover only the hologram diffraction lattices. The exposed regions may be formed at the ends of the surfaces of the hologram devices to be produced and may be formed in regions other than the ends of the surfaces. The mask may be formed by a photolithography and an etching technique.

Next, the above-mentioned step (3), that is, a step of dicing the substrate so as to define the hologram diffraction lattices, will be described.

The dicing can be carried out by using a 0.3 mm-thick dicing blade. By the step, the substrate is diced and respective hologram devices can be obtained.

In the second method, the low moisture-permeable film can be formed with dicing lines covered with a mask (Thus, the film is not formed on the lines), and in such a case the dicing is made easier and the processing speed can be increased and also the life of the blade (a cutting tool) to be used for the dicing is prolonged to result in cost reduction.

The descriptions of the first method which could apply to the second method are included in the descriptions of the second method.

From another aspect, the invention provides an electronic optical part provided with a hologram device described above.

The electronic optical part includes, for example, a hologram laser unit and an optical pick-up.

The hologram unit comprises, for example, a laser unit and a hologram device bonded to each other by an ultraviolet-curable resin. The adhesion may be carried out at 4 points or 4 edges. The laser unit is provided with, for example, a light emitting device, a light receiving device, and a cap surrounding them. The cap is provided with a glass window.

The optical pick-up is provided with, for example, a hologram laser unit, a raising mirror, and an objective lens and the raising mirror reflects the light from the hologram laser unit and leads the light to the objective lens. The light led to the objective lens is converged on a recording medium such as CD-ROM to record or read information.

Since cracks are not easily formed in the hologram device of the invention, defects are not easily caused in the electronic optical part provided with the hologram device and such electronic optical part is provided with high reliability although it is economical.

In this specification, the phrase “on the substrate” includes the concepts that adjacent to the substrate, adjacent to the substrate through a protection film, an insulating film, or other functional films, and above a semiconductor substrate in non-contact state. Also, the phrase “on the substrate” includes the concepts that “in the direction to laminate films”. Accordingly, in the case of forming a multilayer film on the down face of the substrate, the phrase “on the substrate” is used. The phrases “on the film” and “on the layer” are also the same.

### EXAMPLE 1

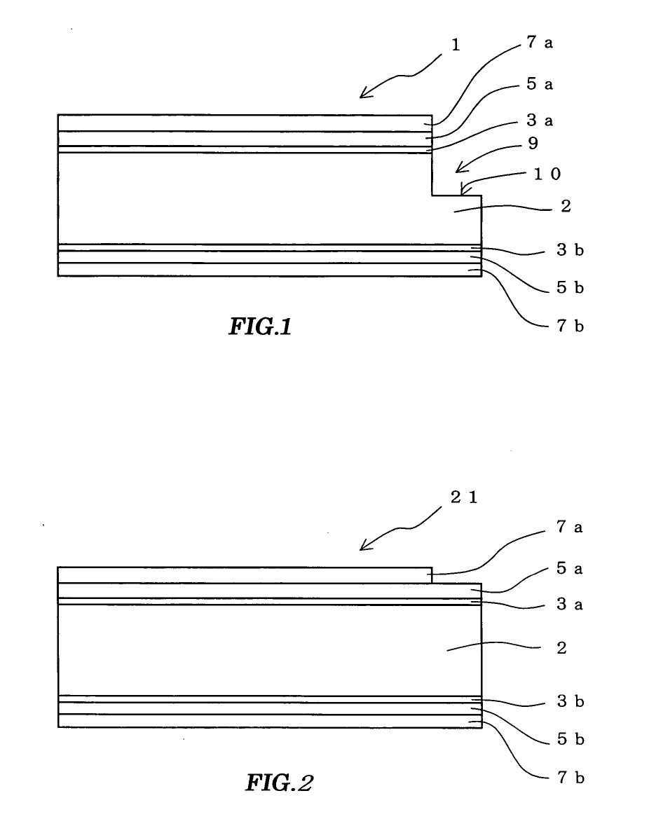

FIG. 1 is a side view showing the structure of a hologram device 1 according to Example 1 of the invention.

The hologram device 1 of this example is provided with a transparent substrate 2. As the transparent substrate 2, an acrylic resin extrusion molded product (trade name: Sumipex; grade name: E 010) manufactured by Sumitomo Chemical Co., Ltd. is used. Primer layers 3a, 3b containing N-vinyl-2-pyrrolidone solvent are formed on both faces of the transparent substrate 2. Ultraviolet-curable resin layers (MP-107) 5a, 5b manufactured by Mitsubishi Rayon Co., Ltd. having fine patterns thereon are formed on the primer layers 3a, 3b. The fine patterns are formed on the ultraviolet-curable resin layers 5a, 5b by a photo polymer method. The fine patterns of the respective ultraviolet-curable resin layers 5a, 5b are aligned each other. Dielectric films 7a, 7b are formed on the ultraviolet-curable resin layers 5a, 5b.

A step 9 is formed in the transparent substrate 2 and no dielectric film is formed on the lower part 10 to expose the transparent substrate 2. Therefore, the transparent substrate 2 could adsorb moisture from the upper side to moderate the swelling strain of the transparent substrate 2.

Hereinafter, a production method of the hologram device 1 will be described with reference to FIG. 1.

(Primer Treatment Step)

Primer layers 3a, 3b are formed on both faces of a transparent substrate 2. Specifically, ten sheets of transparent substrates 2 set in a cassette are immersed in N-vinyl-2-pyrrolidone solvent. Next, excess solvent is removed by using a spin drier, a Rinser Drier MODEL 1600-3 manufactured by Bar Tech Inc. and the substrate is dried at 85° C. for 10 minutes in a clean bake furnace. In the spin drier apparatus, Teflon (a registered trademark) is used as a shield material due to its resistance to this solvent and in consideration of the flammability of the solvent, countermeasure for explosion prevention is carried out.

(Photopolymer Formation Step)

Next, ultraviolet-curable resin layers 5a, 5b having a plurality of hologram diffraction lattices arranged so as to form a matrix are formed on the primer layers 3a, 3b. Specifically, using a photo polymer formation apparatus manufactured by I. Graphic Co., a plurality of the hologram diffraction lattices are formed in an arrangement so as to form a matrix. Ultraviolet-curable resin (MP-107) manufactured by Mitsubishi Rayon Co., Ltd. is used as the material for forming the hologram diffraction lattices.

(Antireflection Film Coating Step)

Dielectric films 7a, 7b as antireflection films are formed on the ultraviolet-curable resin layers 5a, 5b. Specifically, deposition apparatus BMC-850DCI manufactured by Shincron Co. is used to form a double film structure of a ZrO₂+TiO₂ mixed layer and a SiO₂ layer on the ultraviolet-curable resin layer by radio-frequency ion plating method (RF-IP). Since this film has low moisture-permeability, formation of an exposed region not covered with the film is important to lessen swelling strain.

(Groove Processing Step)

Next, a step 9 is formed from the upper side of the transparent substrate 2. Specifically, a dicing apparatus manufactured by Disco Co. is used to form a groove with a depth of 1 mm, which is about a half of the 2 mm-thick acrylic material, and a width of 0.3 mm.

(Dicing Step)

The obtained transparent substrate 2 is diced to complete the production of the hologram device 1. Specifically, a dicing apparatus (the thickness of the blade: 0.3 mm) manufactured by Disco Co. is used to carry out dicing in prescribed size.

If the groove shape is wider in the width and deeper in the groove depth, cracking at a high temperature and high humidity is suppressed more. If the depth of the groove is ¾ or more than the thickness of the substrate, it would be a problem in the strength and therefore the depth is preferably ⅓ to ¾ of the thickness of the substrate. Since the groove width is 0.3 mm equal to the thickness of the blade, the groove can be formed by a single process.

### EXAMPLE 2

FIG. 2 shows a side view showing the structure of a hologram device 21 according to Example 2 of the invention. The difference from the hologram device of Example 1 is whether a step is formed in the transparent substrate 2 or not. The hologram device 21 of this example can be formed as follows.

At first, similarly to Example 1, the primer treatment step and the photo polymer formation step are carried out. Next, a dielectric film is formed by using a mask having openings in regions corresponding to the hologram diffraction lattices. Specifically, a mask having openings with 2.4 mm×2.4 mm size (the size of the hologram device is 3.2 mm×2.4 mm) is used. The dielectric film having exposed regions corresponding to the regions covered with the mask is formed in this step.

Dicing of the transparent substrate 2 is carried out in the same manner as Example 1 to complete production of the hologram device 21.

### EXAMPLE 3

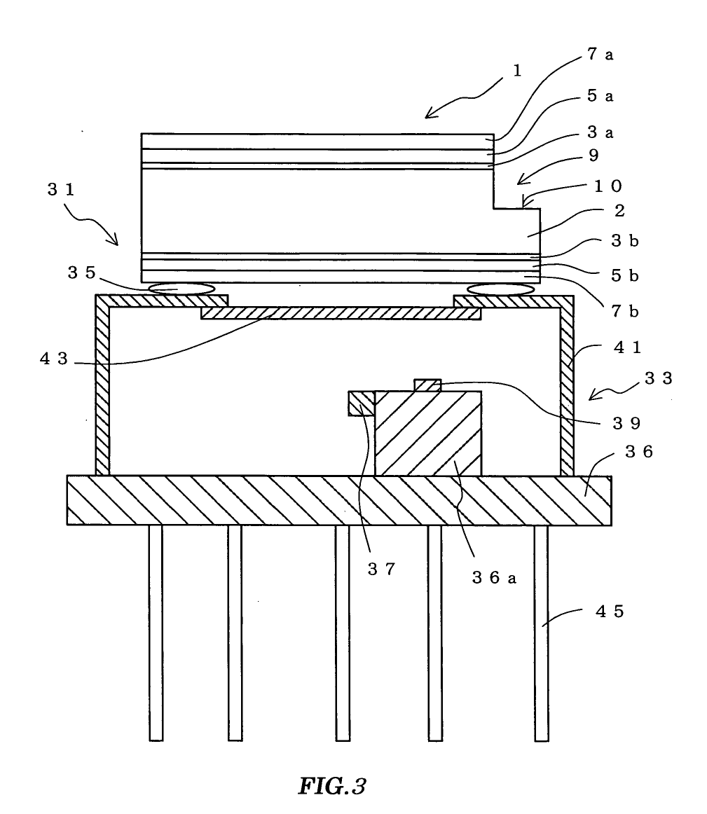

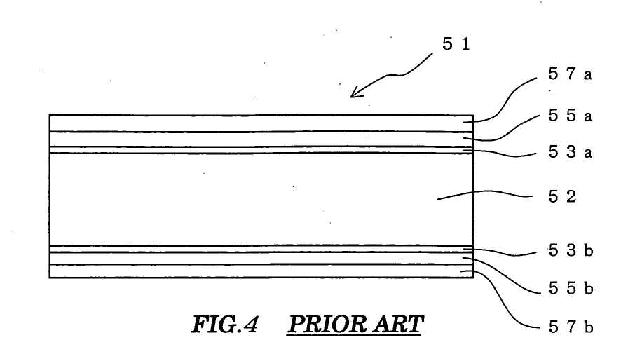

FIG. 3 shows a side view showing the structure of a hologram laser unit 31 according to Example 3 of the invention.

The hologram laser unit 31 comprises the hologram device 1 of Example 1 and the laser unit 33 stuck to each other by an ultraviolet-curable adhesive 35 or the like. The adhesion is carried out by applying the adhesive to all of four edges of the hologram device. The laser unit 33 is provided with a stem 36, a sub-mount 36a, a light emitting device 37, a light receiving device 39, and a cap 41 surrounding them. The cap 41 is provided with a glass window 43. The light emitting device 37 and the light receiving device 39 are electrically connected to electrodes 45.

Such a hologram laser unit 31 was produced and subjected to a high temperature and high humidity test at 65° C. and 95% RH for 300 H to find no crack formation in the hologram device. Also, it was found that no crack was formed after a test at 60° C. and 90% RH for 1000 H. In such a manner, whether a crack is formed or not could be checked by a test in high temperature and high humidity conditions of 60° C. and 90% RH.

The same experiments were carried out for the hologram device 21 of Example 2 to find no crack was formed also in this case.

1. A hologram device comprising a substrate having a hologram diffraction lattice thereon and a low moisture-permeable film formed on the substrate and covering the hologram diffraction lattice, wherein the substrate has an exposed region not covered with the low moisture-permeable film.

2. The hologram device according to claim 1, wherein the substrate has a step at an end of a surface and the exposed region is formed in a lower part of the step.

3. The hologram device according to claim 1, wherein the substrate is made of acrylic resin.

4. The hologram device according to claim 1, wherein the low moisture-permeable film is formed by forming a first layer on the substrate and a second layer thereon, wherein the first layer is a mixed layer of titanium oxide and zirconium oxide and the second layer is a silicon oxide layer.

5. A production method of a hologram device comprising (1) forming a plurality of hologram diffraction lattices on a substrate; (2) forming a low moisture-permeable film on the substrate so as to cover the hologram diffraction lattices; (3) forming grooves with a prescribed depth so as to define the hologram diffraction lattices; and (4) dicing the substrate in such a manner that bottom parts of the grooves remain.

6. A production method of a hologram device comprising (1) forming a plurality of hologram diffraction lattices on a substrate; (2) forming a low moisture-permeable film on the substrate by using a mask having openings in regions corresponding to the hologram diffraction lattices so as to form exposed regions not covered with the low moisture-permeable film on the substrate; and (3) dicing the substrate so as to define the hologram diffraction lattices.

7. An electronic optical part provided with the hologram device according to claim 1.
